(19) United States
(12) Patent Application Publication
(10) Pub. No.: US 2013/0181989 A1
(43) Pub. Date: Jul. 18, 2013

(54) Efficiently Reconstructing Three-Dimensional Structure and Camera Parameters from Images

(71) Applicants: Sameer Agarwal, Lake Washington Park, WA (US); Keir B. Mierle, San Francisco, CA (US)

(72) Inventors: Sameer Agarwal, Lake Washington Park, WA (US); Keir B. Mierle, San Francisco, CA (US)

(21) Appl. No.: 13/789,359

(22) Filed: Mar. 7, 2013

Related U.S. Application Data
(63) Continuation-in-part of application No. 13/295,650, filed on Nov. 14, 2011.

(51) Int. Cl. G06T 17/00

(52) U.S. Cl. CPC G06T 17/00
USPC 345/420

(57) ABSTRACT

A three-dimensional model of a scene is constructed from images of the scene. The three-dimensional model comprises parameters including point parameters describing points of the scene and camera parameters describing cameras that captured the images of the scene. The parameters are iteratively modified by correcting the parameters in each iteration. The corrections to the parameters are determined by solving a sparse equation based on Jacobian of residuals of the parameters. A linear system of equations is formulated by determining row blocks of the Jacobian for each point, processing each row block independent of other row blocks and combining the results. The linear system of equation is solved to determine the corrections to the parameters. The corrections to the parameters are determined without storing the entire Jacobian matrix in memory at the same time. As a result, the construction of the three-dimensional model is performed with fewer memory resources.

### CROSS REFERENCE TO RELATED APPLICATIONS

This application is a continuation-in-part of U.S. application Ser. No. 13/295,650, filed on Nov. 14, 2011, which is incorporated by reference in its entirety. This application also claims the benefit of U.S. Provisional Patent Application No. 61/667,342, filed on Jul. 2, 2012, which is incorporated by reference in its entirety.

### FIELD OF THE INVENTION

This invention relates to reconstructing a three-dimensional structure of a scene and parameters of cameras from a given set of images.

### BACKGROUND

Given a set of images of a scene, numerical techniques can be used to reconstruct the three-dimensional structure of the scene and parameters describing the cameras that captured the images. The three-dimensional structure can be represented as three-dimensional positions of points in the scene. The parameters describing the cameras that captured the images include the positions, orientations, and focal lengths of the cameras. The problem of reconstructing the three-dimensional structure and parameters describing cameras of a scene from images of the scene is called the “bundle adjustment problem.” The bundle adjustment problem can be formulated as a non-linear least squares minimization problem.

The images used for three-dimensional structure reconstruction can be sequences of images captured from a moving camera, for example, a camera mounted on a car, a low flying aircraft, or a hand-pushed trolley in a building. For several applications, the number of photos processed for three-dimensional reconstruction can be tens of thousands or more. Furthermore, the number of points processed in the scene can be hundreds or thousands or more. As a result, the size of the matrices that are processed during the three-dimensional reconstruction process can be very large. Therefore, conventional techniques for three-dimensional reconstruction from images can be inefficient and may require large amount of computing and memory resources.

### SUMMARY

The above and other issues are addressed by a computer-implemented method, computer system, and computer program product for constructing a three-dimensional model for a scene from images of the scene. The three-dimensional model comprises a set of parameters. Embodiments of the method refine the three dimensional model of the scene by iteratively modifying the parameters. The modifying of the parameters comprises determining corrections to the parameters and refining the set of parameters based on the corrections. The corrections to the parameters are determined by solving a sparse linear system of equations comprising a Jacobian matrix obtained from residuals representing an error in the three dimensional model. Solving the sparse linear system of equations comprises determining a row block of the Jacobian matrix for each point. The row block is stored in memory such that it replaces a stored row block for another point determined during the current iteration. A matrix term and a vector term are determined from the stored row block. A linear equation is formulated by combining the matrix terms and vector terms for various points. The linear equation is solved to determine corrections to set of parameters. The corrections to the parameters are used to refine the set of parameters to produce a refined three-dimensional model of the scene.

Embodiments of the computer system for refining a three-dimensional model for a scene from images of the scene comprise a computer processor and a computer-readable storage medium storing computer program modules. The computer program modules comprise a 3-D model construction module configured to iteratively modify a set of parameters representing a three-dimensional model of the scene. The 3-D construction module determines corrections to the set of parameters by solving a sparse linear system of equations comprising a Jacobian matrix. The 3-D construction module solves the sparse linear system of equations by determining a row block of the Jacobian matrix for each point. The row block is stored in memory such that it replaces a stored row block for another point determined during the current iteration. The 3-D construction module determines a matrix term and a vector term from the stored row block and formulates a linear equation by combining the matrix terms and vector terms for various points. The 3-D construction module solves the linear equation to determine corrections to set of parameters. The corrections to the parameters are used to refine the set of parameters to produce a refined three-dimensional model of the scene.

Embodiments of the computer program product for refining a three-dimensional model for a scene from images of the scene have a computer-readable storage medium storing computer-executable code for constructing the three-dimensional model. The computer-executable code comprises computer program modules including a 3-D model construction module. The 3-D model construction module is configured to iteratively modify a set of parameters representing a three-dimensional model of the scene. The 3-D construction module determines corrections to the set of parameters by solving a sparse linear system of equations comprising a Jacobian matrix. The 3-D construction module solves the sparse linear system of equations by determining a row block of the Jacobian matrix for each point. The row block is stored in memory such that it replaces a stored row block for another point determined during the current iteration. The 3-D construction module determines a matrix term and a vector term from the stored row block and formulates a linear equation by combining the matrix terms and vector terms for various points. The 3-D construction module solves the linear equation to determine corrections to set of parameters. The corrections to the parameters are used to refine the set of parameters to produce a refined three-dimensional model of the scene.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates how multiple images of a scene showing an object can be captured by cameras.

FIG. 2 illustrates the process of reconstructing a three-dimensional structure of a scene and parameters of cameras used for capturing images of the scene given a set of images of the scene, according to one embodiment of the present invention.

FIG. 3 is a high-level block diagram illustrating modules within a computer system for performing three-dimensional reconstruction of a scene, according to one embodiment of the present invention.

FIG. 4 is a flow diagram illustrating the overall process for reconstructing a three-dimensional model of a scene from a set of images, according to one embodiment of the present invention.

FIG. 5(a) is a flow diagram illustrating the process for determining a correction to the three-dimensional model, according to one embodiment of the present invention.

FIG. 5(b) is a flow diagram illustrating the process for determining the camera parameters, according to one embodiment of the present invention.

FIG. 6(a) is a flow diagram illustrating the concurrency inherent in the process for determining a set of linear equations for computing the camera parameters, according to one embodiment of the present invention.

FIG. 6(b) is a flow diagram illustrating the concurrency inherent in the process for determining the point parameters, according to one embodiment of the present invention.

FIG. 7 shows a row block buffer for storing row blocks of the Jacobian matrix, in accordance with an embodiment of the invention.

FIG. 8 is a flow diagram illustrating a process for formulating a linear equation for determining corrections to camera parameters, without storing the entire Jacobian matrix in memory at the same time, according to one embodiment of the present invention.

FIG. 9 is a flow diagram illustrating a process for determining corrections to the point parameters given the camera parameters, without storing the entire Jacobian matrix in memory at the same time, according to one embodiment of the present invention.

FIG. 10 is a high-level block diagram illustrating an example of a computer system shown in FIG. 3 according to one embodiment of the present invention.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures.

Figure (FIG.) 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120a” and/or “120b” in the figures).

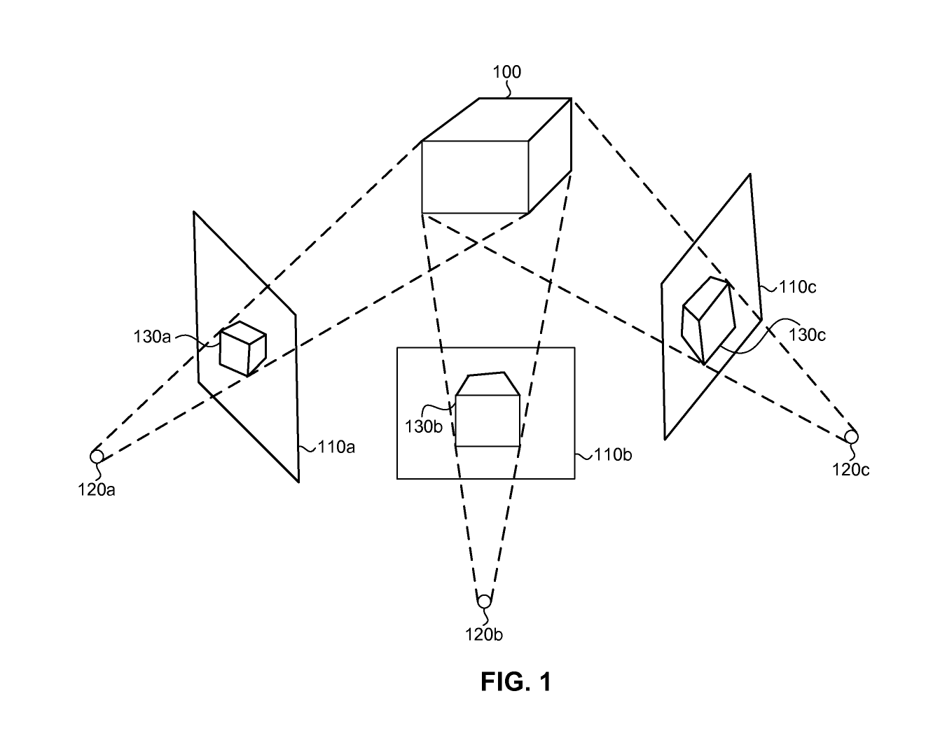

FIG. 1 illustrates how multiple images of a scene showing an object can be captured by cameras. The images 110 of a scene 100 are captured using cameras 120a, 120b, and 120c. Each camera 120 may capture an image 110 of the scene 100 from a different angle. Since each image may be captured from a different angle, each image 110 may show a view 130 of the scene that is different from the view in other images 110. For example, the view 130a captured by camera 120a is different from the view 130b captured by camera 120b, which in turn is different from the view 130c captured by camera 120c. In an embodiment, the same camera may be used to capture multiple images of a scene from different angles. For example, a moving camera may be used to capture images of a scene. The cameras used for capturing the images can be described by various parameters including their locations, orientations, and focal lengths. Other parameters related to cameras include parameters of mechanical devices on which the camera is mounted, for example, parameters describing a servo motor on which a camera may be mounted.

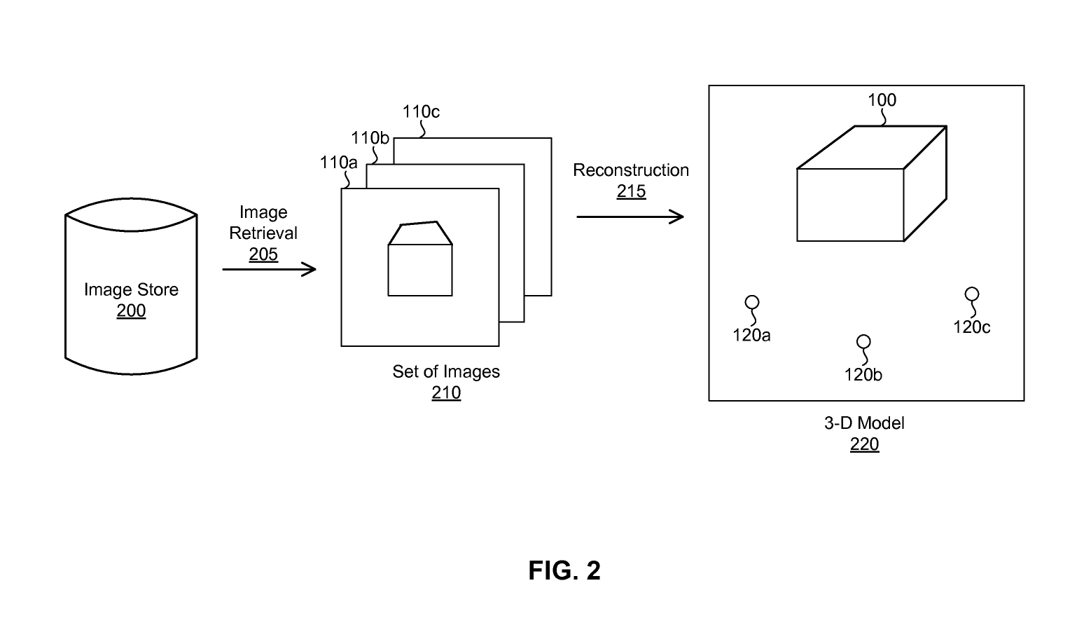

FIG. 2 illustrates the process of reconstructing a three-dimensional structure of a scene and parameters of cameras used for capturing images of the scene given a set of images of the scene, according to one embodiment of the present invention. The three-dimensional structure of a scene and information describing the cameras used for capturing the images can be represented by a three-dimensional model 220. The images of different scenes captured as shown in FIG. 1 can be stored in an image store 200. The set 210 of images of a scene 100 are retrieved 205 from the image store 200. The set 210 of images 110 are processed to perform a reconstruction 215 of the three-dimensional structure of the scene represented as a three-dimensional model 220. The three-dimensional model 220 comprises information describing the scene 100 and information describing the cameras 120. The scene may be described using points. A point corresponds to a 3-D location in the scene that is typically visible as a feature of the scene. A point may be visible in one or more images and may correspond to pixels in the images that show the point. A point of the scene may correspond to an object of the scene. For example, a scene may show a three dimensional cube that has points corresponding to the corners, points corresponding to the edges, or points corresponding to the faces of the cube. A point need not correspond to an object of the scene. For example, a point may correspond to a shadow in a scene or a portion of a scene displaying certain texture. The information describing the scene 100 comprises information describing the points of the scene, for example, three-dimensional positions of the points. The information describing the cameras may comprise the position, orientation, and focal length of the cameras 120 used to capture the images 110.

### System Environment and Architectural Overview

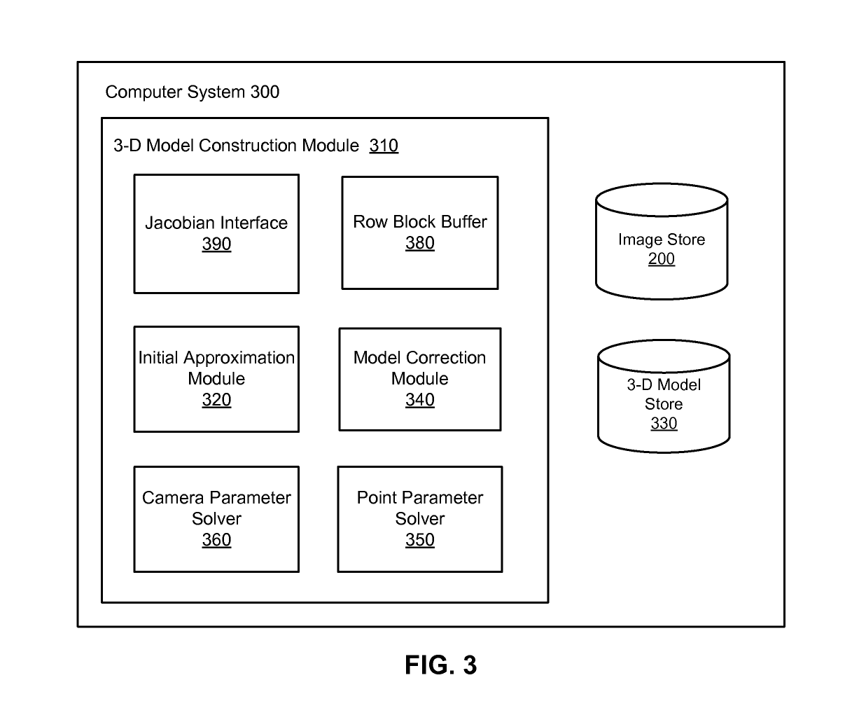

FIG. 3 is a high-level block diagram illustrating modules within a computer system 300 for performing three-dimensional reconstruction of a scene, according to one embodiment of the present invention. In one embodiment, the computer system 300 can be a conventional computer system executing, for example, a Microsoft Windows-compatible operating system (OS), Apple OS X, and/or a Linux distribution. In another embodiment, the computer system 300 can be a device having computer functionality, such as a personal digital assistant (PDA), mobile telephone, video game system, etc.

The computer system 300 comprises a three-dimensional (3-D) model construction module 310, an image store 200, and a 3-D model store 330. Some embodiments of the computer system 300 have different and/or other modules than the ones described herein, and the functions can be distributed among the modules in a different manner than described here. For example, the computer system 300 might also include modules for receiving images via a network or modules for transmitting information describing the 3-D model via the network.

The image store 200 stores sets of images of scenes. The images can be, for example, still images or images contained in frames of a video. The images can show different types of entities such as buildings, people, animals, birds, trees, natural scenery or combinations of these. The images may be collected from different sources, for example, images uploaded by users of an image storage system, images obtained by professional stock photography, image galleries, and images specifically captured for purposes of 3-D model construction. The image store 200 typically stores sets of images for each entity, for example, different images of an entity captured from different angles. Examples of images stored in the image store 200 include images of buildings along a street captured by a moving car or images of inside of a building captured by a camera carried on a trolley within the building.

The 3-D model store 330 stores the 3-D models 220 generated by the 3-D model construction module 310 for describing various scenes. In an embodiment, the 3-D models 220 are represented as vectors comprising information describing the points of the scene and information describing the cameras 120 that captured the images. The information describing the points in a 3-D model may comprise positions of the points represented as three-dimensional coordinates. Information describing the cameras may comprise the position, orientation, and focal length of the cameras. The elements of the vectors that represent the point information are called the “point parameters” and the elements that represent the camera information are called the “camera parameters.”

The 3-D model construction module 310 retrieves sets of images of a scene from the image store 200, reconstructs a 3-D model for the scene and stores the reconstructed 3-D model in the 3-D model store 330. The 3-D model construction module 310 module builds an initial approximation of the 3-D model for a scene, and iteratively improves upon the 3-D model to generate more and more accurate models of the scene. To this end, the 3-D model construction module 310 includes an initial approximation module 320, a model correction module 340, a point parameter solver 350, a camera parameter solver 360, a Jacobian interface 390, and a row block buffer 380.

The initial approximation module 320 generates an initial approximation of a 3-D model for representing a scene described by a set of images. Points of the scene may not be visible in every image of the scene. For example, a point of the scene may be visible in one image but not visible in another image. The initial approximation module 320 correlates the points from various images of a scene to determine a complete set of points of the scene that are observed in the different images of the scene.

In an embodiment, the camera equipment used for capturing the images may have a global positioning system (GPS) for determining initial approximations of the positions and orientations of the cameras. For example, the camera may be carried in a car or aircraft that captures pictures while it is moving. The car or aircraft carrying the camera may have GPS. The information obtained from the GPS may be stored along with the images in the image store 200. The initial approximation module 320 retrieves the camera positions as provided by the GPS and determines positions of the points of the scene by processing the camera positions, for example, by triangulation of points. The initial approximation module 320 may generate an approximate 3-D model and improve the 3-D model using simplified techniques that are not very computation intensive. In an embodiment, the initial approximation of the 3-D model is obtained from an external system. In this embodiment, the initial approximation module 320 receives the initial values of parameters of the 3-D model and assigns the received initial values to the parameters.

The model correction module 340 improves upon the initial approximation of the 3-D model by determining corrections to the 3-D model. In one embodiment, the model correction module 340 formulates the model reconstruction problem as a non-linear optimization problem and iteratively solves the non-linear optimization problem. Each iteration of the non-linear optimization problem determines a correction of the 3-D model. The model correction module 340 iteratively improves the 3-D model by updating the model using the correction of the model. The model correction module 340 uses certain convergence criteria to determine the number of iterations used for making corrections to the model. The final 3-D model of the scene generated by the model correction module 340 is stored in the 3-D model store 330.

The model correction module 340 invokes the camera parameter solver 360 and the point parameter solver 350 for determining a correction to the model. The camera parameter solver 360 performs the steps of the non-linear optimization problem that determine the corrections to the camera parameters of the 3-D model. The point parameter solver 350 performs the steps of the non-linear optimization problem that determine the corrections to the point parameters of the 3-D model. The camera parameter solver 360 provides the values of the correction to the camera parameters to the point parameter solver 350 for use in determining the point parameters. The details of the steps of the non-linear optimization performed by the model correction module 340, the camera parameter solver, and the point parameter solver 350 are further described herein.

The Jacobian interface 390 computes row blocks of the Jacobian matrix and stores them in the row block buffers 380. The Jacobian interface 390 allows other modules to access row blocks of the Jacobian matrix. For example, the model correction module 340 requests the Jacobian interface 390 to provide the row block corresponding to particular point and the Jacobian interface 390 returns the requested row block. The Jacobian interface 390 may compute the requested row block on demand or the Jacobian interface 390 may obtained the row block from the row block buffer 380 if pre-computed.

### Formulation of Three-Dimensional Reconstruction Process

The following discussion describes the mathematical underpinnings used by the 3-d model construction module 310 to perform 3-d reconstruction. The three-dimensional model 220 is represented as a block-structured vector x called a “parameter vector” as defined by equation (1). In equation (1), each xᵢ is a vector of scalars and is called a parameter block. Each parameter block typically comprises 1 to 10 components. The vector x typically has from a few hundred thousand to millions of parameter blocks.

$$x = [ \begin{matrix}{x}_{1} \\ ⋮ \\ {x}_{n}\end{matrix} ] \qquad ( 1 )$$

The three-dimensional reconstruction problem can be formulated as a non-linear least squares minimization process. The non-linear least squares minimization process minimizes an estimate of an error in the three-dimensional model 220. The error in the three-dimensional model 220 can be represented as a residual vector comprising the differences between projections of the points of the scene 100 represented by the three-dimensional model 220 onto the image planes of the cameras and the actual positions of the points in the corresponding images. An example of a metric based on the estimate of the error is the squared L₂ norm of the residual vector.

The residual representing the error in the three-dimensional model 220 can be represented as a residual vector F(x) as shown in equation (2). The residual vector F(x) comprises individual elements fᵢ(x), where each fᵢ(x) is referred to as a residual block.

$$F ( x ) = [ \begin{matrix}{f}_{1} ( x ) \\ ⋮ \\ {f}_{m} ( x )\end{matrix} ] \qquad ( 2 )$$

A residual block fᵢ(x) represents the error between observations in images and the current estimate of the three-dimensional point being observed in that image and the camera parameters for that image. Residual blocks are vectors that typically have from 1 to 6 elements. The value of m can vary from hundreds of thousands for medium scale problems to tens of millions for large problems.

The process of minimizing the error for performing the three-dimensional reconstruction process 215 can be represented as the process of minimizing the L₂ norm of F(x) as represented by the expression in equation (3).

$$\begin{matrix}min \\ x\end{matrix} \frac{1}{2} {‖ F ( x ) ‖}^{2} \qquad ( 3 )$$

The non-linear optimization problem represented by equation (3) can be solved by solving a sequence of approximations to the original problem. At each iteration, the approximation is solved to determine a correction Δx to the vector x. For non-linear least squares, the term F(x) can be approximated by using the linearization F(x+Δx)≈F(x)+J(x)Δx, where J(x) is the Jacobian of F(x). The matrix J(x) is a block structured matrix and comprises terms Jᵢⱼ(x)=∂ⱼfᵢ(x) where each Jᵢⱼ(x) is the Jacobian of the i^{th} residual block with respect to the j^{th} parameter block. The term Jᵢ represents a row block, corresponding to the Jacobian of the i^{th} residual block. Typically, J(x) is an extremely sparse matrix. Each residual block fᵢ(x) depends on a very small number of parameter blocks, typically 1 to 5 blocks.

Using the linearization F(x+Δx)≈(x)+J(x)Δx, equation (3) can be approximated by equation (4).

$$\begin{matrix}min \\ Δ x\end{matrix} \frac{1}{2} {‖ J ( x ) Δ x + F ( x ) ‖}^{2} \qquad ( 4 )$$

However, solving a sequence of these problems naively and updating x by (x+Δx) leads to a process that may not converge. In order to ensure that the process converges, the size of the step Δx is controlled, for example, by introducing a regularization term as shown in equation (5).

$$\begin{matrix}min \\ Δ x\end{matrix} \frac{1}{2} {‖ J ( x ) Δ x + F ( x ) ‖}^{2} + μ {‖ D ( x ) Δ ( x ) ‖}^{2} \qquad ( 5 )$$

In equation (5), D(x) is a non-negative diagonal matrix, typically the square root of the diagonal of the matrix J(x)^{T}J(x) and μ is a non-negative parameter that controls the strength of regularization. It can be shown that the step size ∥Δ(x)∥ is inversely related to μ. The value of μ is updated at each step based on how well the Jacobian J(x) approximates F(x). The quality of this fit is measured by the ratio of the actual decrease in the objective function to the decrease in the value of the linearized model

$$L ( Δ x ) = \frac{1}{2} {‖ J ( x ) Δ x + F ( x ) ‖}^{2} .$$

The dominant computational cost in each iteration of the non-linear optimization of the term represented by equation (3) is the solution of the linear least squares problem represented by equation (5). The equation (5) can be transformed into equation (6).

$$\begin{matrix}min \\ Δ x\end{matrix} \frac{1}{2} {‖ [ \begin{matrix}J \\ \sqrt{2 μ D}\end{matrix} ] Δ x + [ \begin{matrix}f \\ 0\end{matrix} ] ‖}^{2} \qquad ( 6 )$$

For purposes of simplifying the notation, it is assumed that the matrix \sqrt{2μD} is concatenated at the bottom of the matrix J and a vector of zeros is added to the bottom of the vector f. Accordingly, equation (6) can be transformed into equation (7).

$$\begin{matrix}min \\ Δ x\end{matrix} \frac{1}{2} {‖ J ( x ) Δ x + F ( x ) ‖}^{2} \qquad ( 7 )$$

If the vector x represented in equation (1) comprises nₚ points and n_{c} cameras, the parameter blocks can be ordered such that all the parameter blocks representing points are ordered before the parameter blocks representing cameras. As a result of this reordering, the vector x can be represented as shown in equation (8), where {x₁, . . . xₙ_{ₚ}} are the parameter blocks for the points (called the point parameter blocks) and {xₙ_{ₚ}₊₁, . . . , xₙ_{ₚ}₊ₙ_{_{c}}} are the parameter blocks for the cameras (called the camera parameter blocks).

$$x = [ \begin{matrix}{x}_{1} \\ ⋮ \\ {x}_{{n}_{p}} \\ {x}_{{n}_{p} + 1} \\ ⋮ \\ {x}_{{n}_{p} + {n}_{c}}\end{matrix} ] \qquad ( 8 )$$

The residual vector F(x) can be sorted in order of the point parameter blocks such that all residual blocks that depend on a particular point are grouped together. Equation (9) shows an example of the Jacobian matrix J for a three-dimensional reconstruction process based on 5 points and 3 cameras. As shown in equation (9), Q_{i,j} refers to a non-zero Jacobian block representing observation i corresponding to point parameter block of point j. Furthermore, K_{i,k} refers to a non-zero Jacobian block corresponding to camera parameter block of camera k used to capture observation i. Each term Q_{i,j} may correspond a 2×3 matrix such that each row corresponds to a coordinate of a 2-D observation and each column corresponds to the point parameters associated with the 3-D representation of the point. Similarly, each term K_{i,k} may correspond to a 2×7 matrix such that each row corresponds to a coordinate of a 2-D observation and each column corresponds to camera parameters associated with the camera, assuming there are 7 parameters of the camera.

$$J = [ \begin{matrix}{Q}_{1 , 1} & 0 & 0 & 0 & 0 & {K}_{1 , 1} & 0 & {K}_{1 , 3} \\ {Q}_{2 , 1} & 0 & 0 & 0 & 0 & 0 & {K}_{2 , 2} & 0 \\ {Q}_{3 , 1} & 0 & 0 & 0 & 0 & 0 & 0 & {K}_{3 , 3} \\ 0 & {Q}_{4 , 2} & 0 & 0 & 0 & 0 & {K}_{4 , 2} & 0 \\ 0 & {Q}_{5 , 2} & 0 & 0 & 0 & {K}_{5 , 1} & 0 & 0 \\ 0 & 0 & {Q}_{6 , 3} & 0 & 0 & {K}_{6 , 1} & {K}_{6 , 2} & 0 \\ 0 & 0 & {Q}_{7 , 3} & 0 & 0 & 0 & {K}_{7 , 2} & 0 \\ 0 & 0 & {Q}_{8 , 3} & 0 & 0 & 0 & 0 & {K}_{8 , 3} \\ 0 & 0 & {Q}_{9 , 3} & 0 & 0 & 0 & 0 & {K}_{9 , 3} \\ 0 & 0 & 0 & {Q}_{10 , 4} & 0 & {K}_{10 , 1} & 0 & 0 \\ 0 & 0 & 0 & 0 & {Q}_{11 , 5} & 0 & {K}_{11 , 2} & 0 \\ 0 & 0 & 0 & 0 & 0 & {K}_{12 , 1} & 0 & {K}_{12 , 3} \\ 0 & 0 & 0 & 0 & 0 & 0 & {K}_{13 , 2} & {K}_{13 , 3} \\ 0 & 0 & 0 & 0 & 0 & {K}_{14 , 1} & {K}_{14 , 2} & 0\end{matrix} ] \qquad ( 9 )$$

The matrix J shown in equation (9) can be represented as J=[P C] by vertically partitioning J into two matrices P and C. The Jacobian matrix J can be written as shown in equation (10), where each Pᵢ contains Jacobian blocks corresponding to the point parameter blocks for point i. Similarly, each Cᵢ corresponds to Jacobian blocks corresponding to camera parameter blocks for point i. As shown in equations (10), the matrix P is block diagonal matrix and matrix C is a general block sparse matrix.

$$J = [ \begin{matrix}{P}_{1} & 0 & 0 & 0 & 0 & {C}_{1} \\ 0 & {P}_{2} & 0 & 0 & 0 & {C}_{2} \\ 0 & 0 & {P}_{3} & 0 & 0 & {C}_{3} \\ 0 & 0 & 0 & {P}_{4} & 0 & {C}_{4} \\ 0 & 0 & 0 & 0 & {P}_{5} & {C}_{5} \\ 0 & 0 & 0 & 0 & 0 & {C}_{6}\end{matrix} ] \qquad ( 10 )$$

For example, in equation (10),

$${P}_{3} = [ \begin{matrix}{Q}_{6 , 3} \\ {Q}_{7 , 3} \\ {Q}_{8 , 3} \\ {Q}_{9 , 3}\end{matrix} ] and {C}_{3} = [ \begin{matrix}{K}_{6 , 1} & {K}_{6 , 2} & 0 \\ 0 & {K}_{7 , 2} & 0 \\ 0 & 0 & {K}_{8 , 3} \\ 0 & 0 & {K}_{9 , 3}\end{matrix} ] .$$

Solving the minimization problem represented by equation (7) can be shown to be equivalent to solving the system of normal equations (11).

J^{T}JΔx=J^{T}f (11)

Assuming g=J^{T}f, equation (11) can be written as equation (12), where

$$g = [ \begin{matrix}{g}_{p} \\ {g}_{c}\end{matrix} ] ,$$

the portion gₚ comprises the values corresponding to the point parameters and g_{c} comprises the values corresponding to the camera parameters. Similarly, Δxₚ comprises the values of the correction to the point parameters and Δx_{c} comprises the values of the correction to the camera parameters.

$$[ \begin{matrix}{P}^{T} P & {P}^{T} C \\ {C}^{T} P & {C}^{T} C\end{matrix} ] [ \begin{matrix}Δ {x}_{p} \\ Δ {x}_{c}\end{matrix} ] = [ \begin{matrix}{g}_{p} \\ {g}_{c}\end{matrix} ] \qquad ( 12 )$$

Equation (12) is a system of equations that can be represented as individual equations (13) and (14).

P^{T}PΔxₚ+P^{T}CΔx_{c}=gₚ (13 )

C^{T}PΔxₚ+C^{T}CΔx_{c}=g_{c} (14)

The linear systems of equations (13) and (14) can be transformed into the equations (15) and (16).

[C^{T}C−C^{T}P[P^{T}P]⁻¹P^{T}C]Δx_{c}=g_{c}−C^{T}P[P^{T}P]⁻¹gₚ (15)

[C^{T}C−C^{T}P[P^{T}P]⁻¹P^{T}C]Δx_{c}=[C^{T}−C^{T}P[p^{T}P]⁻¹P^{T}]f (16)

The matrix S=C^{T}C−C^{T}P[P^{T}P]⁻¹ P^{T}C is referred to as the Schur complement. The equation (16) can be represented as S×Δx_{c}=R, where R is a vector obtained by equation (17),

R=[C^{T}−C^{T}P [P^{T}P]⁻¹P^{T}]f (17)

Equation (16) is a linear equation that can be solved using linear algebra techniques, for example, Cholesky factorization or conjugate gradient method. The solution of equation (16) provides the value of Δx_{c}. Using the value of Δx_{c}, the value of Δxₚ can be obtained by back substitution into equations (13) or (14), resulting in equations (18) and (19).

Δxₚ=[P^{T}P]⁻¹[gₚP^{T}CΔx_{c}] (18)

Δxₚ=[P^{T}P]⁻¹P^{T}[f−CΔx_{c}] (19)

The Schur complement matrix S can be determined by representing the matrix on the left hand side of equation (12) as equation (20) and computing S=W−V^{T}U⁻¹V based on equation (20).

$$[ \begin{matrix}{P}^{T} P & {P}^{T} C \\ {C}^{T} P & {C}^{T} C\end{matrix} ] = [ \begin{matrix}U & V \\ {V}^{T} & W\end{matrix} ] \qquad ( 20 )$$

The matrix P^{T}P has a block sparse structure represented by equation (21).

$${P}^{T} P = [ \begin{matrix}{P}_{1}^{T} {P}_{1} & 0 & 0 & 0 & 0 & 0 \\ 0 & {P}_{2}^{T} {P}_{2} & 0 & 0 & 0 & 0 \\ 0 & 0 & {P}_{3}^{T} {P}_{3} & 0 & 0 & 0 \\ 0 & 0 & 0 & {P}_{4}^{T} {P}_{4} & 0 & 0 \\ 0 & 0 & 0 & 0 & {P}_{5}^{T} {P}_{5} & 0 \\ 0 & 0 & 0 & 0 & 0 & 0\end{matrix} ] \qquad ( 21 )$$

The term P^{T}C can be represented by equations (22) and (23).

$$\begin{matrix}{P}^{T} C = [ \begin{matrix}{P}_{1}^{T} & 0 & 0 & 0 & 0 & 0 \\ 0 & {P}_{2}^{T} & 0 & 0 & 0 & 0 \\ 0 & 0 & {P}_{3}^{T} & 0 & 0 & 0 \\ 0 & 0 & 0 & {P}_{4}^{T} & 0 & 0 \\ 0 & 0 & 0 & 0 & {P}_{5}^{T} & 0\end{matrix} ] [ \begin{matrix}{C}_{1} \\ {C}_{2} \\ {C}_{3} \\ {C}_{4} \\ {C}_{5} \\ {C}_{6}\end{matrix} ] & ( 22 ) \\ {P}^{T} C = [ \begin{matrix}{P}_{1}^{T} {C}_{1} \\ {P}_{2}^{T} {C}_{2} \\ {P}_{3}^{T} {C}_{3} \\ {P}_{4}^{T} {C}_{4} \\ {P}_{5}^{T} {C}_{5} \\ 0\end{matrix} ] & ( 23 )\end{matrix}$$

Accordingly, matrix S=C^{T}C−C^{T}P[P^{T}P]¹P^{T}C can be represented by equation (24).

$$S = [ \begin{matrix}{C}_{1}^{T} & {C}_{2}^{T} & {C}_{3}^{T} & {C}_{4}^{T} & {C}_{5}^{T} & {C}_{6}^{T}\end{matrix} ] [ \begin{matrix}{C}_{1} \\ {C}_{2} \\ {C}_{3} \\ {C}_{4} \\ {C}_{5} \\ {C}_{6}\end{matrix} ] - [ \begin{matrix}{C}_{1}^{T} & {P}_{1} & {C}_{2}^{T} & {P}_{2} & {C}_{3}^{T} & {P}_{3} & {C}_{4}^{T} & {P}_{4} & {C}_{5}^{T} & {P}_{5} & 0\end{matrix} ] {[ \begin{matrix}{P}_{1}^{T} {P}_{1} & 0 & 0 & 0 & 0 & 0 \\ 0 & {P}_{2}^{T} {P}_{2} & 0 & 0 & 0 & 0 \\ 0 & 0 & {P}_{3}^{T} {P}_{3} & 0 & 0 & 0 \\ 0 & 0 & 0 & {P}_{4}^{T} {P}_{4} & 0 & 0 \\ 0 & 0 & 0 & 0 & {P}_{5}^{T} {P}_{5} & 0 \\ 0 & 0 & 0 & 0 & 0 & 0\end{matrix} ]}^{- 1} [ \begin{matrix}{P}_{1}^{T} {C}_{1} \\ {P}_{2}^{T} {C}_{2} \\ {P}_{3}^{T} {C}_{3} \\ {P}_{4}^{T} {C}_{4} \\ {P}_{5}^{T} {C}_{5} \\ 0\end{matrix} ] \qquad ( 24 )$$

When the matrix [P^{T} P]is rank deficient as in this example, the inverse [_{P}^{T} P]⁻¹ could be a pseudo-inverse. For example, the pseudo-inverse of matrix [P^{T} P] can be represented as equation (24).

$$[ \begin{matrix}{[ {P}_{1}^{T} {P}_{1} ]}^{- 1} & 0 & 0 & 0 & 0 & 0 \\ 0 & {[ {P}_{2}^{T} {P}_{2} ]}^{- 1} & 0 & 0 & 0 & 0 \\ 0 & 0 & {[ {P}_{3}^{T} {P}_{3} ]}^{- 1} & 0 & 0 & 0 \\ 0 & 0 & 0 & {[ {P}_{4}^{T} {P}_{4} ]}^{- 1} & 0 & 0 \\ 0 & 0 & 0 & 0 & {[ {P}_{5}^{T} {P}_{5} ]}^{- 1} & 0 \\ 0 & 0 & 0 & 0 & 0 & 0\end{matrix} ] \qquad ( 25 )$$

The equation (24) can be transformed into equation (26).

$$S = {\sum }_{i}^{6} {C}_{i}^{T} {C}_{i} - {\sum }_{i}^{5} {C}_{i}^{T} {{P}_{i} [ {P}_{i}^{T} {P}_{i} ]}^{- 1} {P}_{i}^{T} {C}_{i} \qquad ( 26 )$$

If the term P₆ is defined as P₆=0, and term [P₆^{T}P₆]⁻¹ defined as [P₆^{T}P₆]⁻¹=0, equation (26) can be represented as equation (27).

$$S = {\sum }_{i}^{6} [ {C}_{i}^{T} {C}_{i} - {C}_{i}^{T} {{P}_{i} [ {P}_{i}^{T} {P}_{i} ]}^{- 1} {P}_{i}^{T} {C}_{i} ] \qquad ( 27 )$$

The representation shown in equation (27) allows the matrix S to be computed by determining individual terms of the summation in equation (27) one point parameter block at a time independent of other points by making a single sweep of the matrix J. An individual term of the summation of equation (27) can be represented as follows in equation (28).

Sᵢ=Cᵢ^{T}Cᵢ−Cᵢ^{T}Pᵢ[Pᵢ^{T}Pᵢ]⁻¹Pᵢ^{T}Cᵢ (28)

Similarly the vector R shown in equation (17) can be represented as equation (29).

$$R = {\sum }_{i}^{6} [ {C}_{i}^{T} - {C}_{i}^{T} {{P}_{i} [ {P}_{i}^{T} {P}_{i} ]}^{- 1} {P}_{i}^{T} {C}_{i} ] f \qquad ( 29 )$$

The representation shown in equation (29) allows the vector R to be computed by determining individual terms of the summation, one point parameter block at a time independent of other points by making a single sweep of the matrix J. Individual terms of the summation in equation (29) can be represented as equation (30) as follows.

Uᵢ=[Cᵢ^{T}Cᵢ−Cᵢ^{T}P_{i[P}ᵢ^{T}Pᵢ]⁻¹Pᵢ^{T}]f (30)

The terms of equation (30), can be computed along with the corresponding terms of equation (28) one point at a time by making a single sweep of the matrix J. Determining values of S and R provides the terms on the left and right hand side of equation (16) respectively, i.e., S×Δx_{c}=R. Equation (16) can be solved using linear algebra techniques including Cholesky factorization or conjugate gradient method to obtain the value of Δx_{c}. The value of Δxₚ can be obtained by back substitution into equation (18). The back substitution step corresponding to equation (18) can be represented by equation (29) and can also be computed on a per point basis independent of other points.

Δxₚᵢ=[P₁^{T}Pᵢ]⁻¹[gₚᵢ−Pᵢ^{T}CᵢΔx_{c}] (31)

The computation of individual terms corresponding to equations (28), (30), and (31) can be performed by accessing specific portions of the Jmatrix. Furthermore, a portion of matrix J that is accessed for computing Sᵢ, Uᵢ, or Δxₚᵢ using equations (28), (30), and (31) respectively for a particular value of i=i1 is not accessed for computing the corresponding values for another value of i=i2. In other words, while accessing the values Pᵢ and Cᵢ for computing the values of Sᵢ, Uᵢ, or Δxₚᵢ, there is no need to access any other portions of matrix J, e.g., Pⱼ or Cⱼ such j≠i. As a result, the above computations of matrix S and value of Δxₚ can performed without storing the entire J matrix in memory at the same time.

The computation of Sᵢ in equation (28) can be expressed in terms of the following computations. The term Pᵢ^{T}Pᵢ can be represented as Dᵢ in equation (32).

$${D}_{i} = {P}_{i}^{T} {P}_{i} = {\sum }_{j} {Q}_{j , i}^{T} {Q}_{j , i} \qquad ( 32 )$$

The term Pᵢ^{T}Cᵢ can be represented as E_{i,k} shown in equation (33).

$${E}_{i , k} = {P}_{i}^{T} {C}_{i} = {\sum }_{j} {Q}_{j , i}^{T} {K}_{j , k} \qquad ( 33 )$$

The term Cᵢ^{T}Cᵢ can be represented as H_{i,k,l} as shown in equation (34).

$${H}_{i , k , l} = {C}_{i}^{T} {C}_{i} = {\sum }_{j} {C}_{j , k}^{T} {C}_{j , l} \qquad ( 34 )$$

The various terms E_{i,k} can be represented as Eᵢ as shown in equation (35).

$${E}_{i} = [ \begin{matrix}{E}_{i , 1} \\ ⋮ \\ {E}_{i , m}\end{matrix} ] \qquad ( 35 )$$

Similarly, the various terms H_{i,k,l} can be represented as Hᵢ as shown in equation (36).

$${H}_{i} = [ \begin{matrix}{H}_{1 , 1 , 1 ,} & … & {H}_{1 , 1 , m} \\ & ⋮ & \\ {H}_{1 , m , 1} & … & {H}_{1 , m , m}\end{matrix} ] \qquad ( 36 )$$

The term Dᵢ represents a single matrix, the term Eᵢ represents a dense matrix and Hᵢ represents a block sparse matrix. The three terms Dᵢ, Eᵢ, and Hᵢ can be computed in a single pass over the rows of Pᵢ and Cᵢ. These values can be used to compute the value of Sᵢ as shown in equation (37) that is equivalent to equation (28).

Sᵢ=Hᵢ−Eᵢ^{T}Dᵢ⁻¹Eᵢ (37)

The value of S can be determined using equation (38) which is equivalent of equation (27).

$$S = {\sum }_{i} {S}_{i} \qquad ( 38 )$$

The value of S can be computed while accessing only a single row block of J, which is typically a small number of rows, for example 2 or 3 rows at a time. Furthermore, each row is accessed once for the computation of a value of S. Thus the Schur complement matrix S can be computed without storing the potentially large matrix J in memory.

Similarly, the computation of R as shown in equation (29) can be performed by making a single pass over the rows of matrix J. For example, each term of summation shown in equation (29) can be represented as as shown in equation (39).

$${R}_{i} = {\sum }_{i} [ \begin{matrix}{C}_{i}^{T} - {C}_{i}^{T} & {{P}_{i} [ \begin{matrix}{P}_{i}^{T} & P\end{matrix} ]}^{- 1} & {P}_{i}^{T}\end{matrix} ] f \qquad ( 39 )$$

The term Cᵢ^{T}f is represented as Mᵢ as shown in equation (40).

Mᵢ=Cᵢ^{T}f (40)

Similarly, the term Pᵢ^{T}f is represented as Nᵢ as shown in equation (41).

N=Pᵢ^{T}f (41)

The term Rᵢ as shown in equation (39) can be represented as shown in equation (42) in terms of Mᵢ and Nᵢ.

Rᵢ=Mᵢ−EᵢDᵢ⁻¹Nᵢ (42)

As shown in equation (42), each term Rᵢ can be computed by going over the rows of Cᵢ and Pᵢ once. This computation of Rᵢ can be carried out simultaneously with the computation of S. Therefore, the computations of both Rᵢ and S can be performed via a single pass over the rows of J.

Similarly, the back substitution step represented as equation (31) can be represented as equation (43).

Δxₚᵢ=Dᵢ^{T}[gₚᵢ−EᵢΔx_{c}] (43)

Each term Δxₚᵢ can be computed by going over the rows of Cᵢ and Pᵢ once.

### Reconstructing the 3-D Model

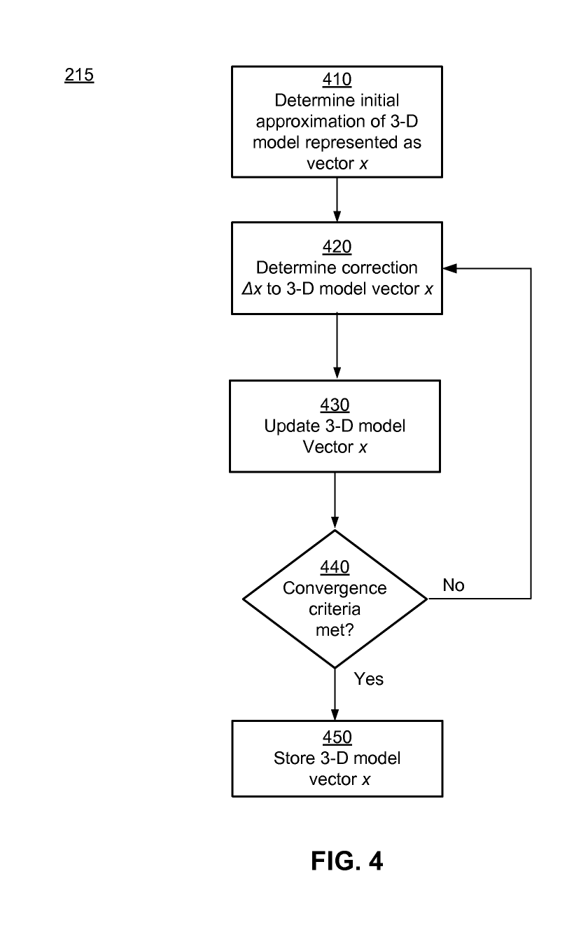

FIG. 4 is a flow diagram illustrating the overall process for reconstructing a 3-D model of a scene from a set of images performed by the 3-D model construction module 310, according to one embodiment of the present invention. The initial approximation module 320 determines 410 an initial approximation of the 3-D model 220. In an embodiment, the initial approximation module 320 retrieves a set of images of a scene from the image store 200 and determines an initial approximation to the 3-D model describing the scene by processing the information describing the images, for example, the positions and orientations of the cameras if available. The initial approximation module 320 may represent the initial approximation of the 3-D model as a block structured vector x like that shown in equation (1). The initial approximation module 320 may either store the representation of the initial approximation in the 3-D model store 330 for further processing or pass the initial approximation representation to the model correction module 340 as a parameter.

The model correction module 340 determines 420 a correction Δx to the initial approximation of the 3-D model. In an embodiment, determining 420 the correction Δx comprises solving equation (10), i.e. JΔx=f. The model correction module 340 invokes other modules including the camera parameter solver 360 and the point parameter solver 350 for solving the equation (10) to determine 420 the correction value Δx. The model correction module 340 updates 430 the 3-D model based on the correction Δx.

The model correction module 340 iteratively repeats the steps of determining 420 the correction Δx and updating 430 the representation of the 3-D model until certain convergence criteria are met 440. The convergence criteria may comprise verifying 440 that the correction value Δx is below a predetermined threshold value. In an embodiment, the convergence criterion determines whether an aggregate measure based on the correction value Δx is below a threshold predetermined value. Accordingly, the model correction module 340 continues correcting the 3-D model while a significant improvement is obtained by correcting the model. In other embodiments, the model correction module 340 may repeat the steps 420, 430, and 440 a predetermined number of times. The model correction module 340 stores the final representation x of the 3-D model in the 3-D model store 330. In some embodiments, the model correction module 340 may store intermediate representations, for example, values of vector x after each iteration.

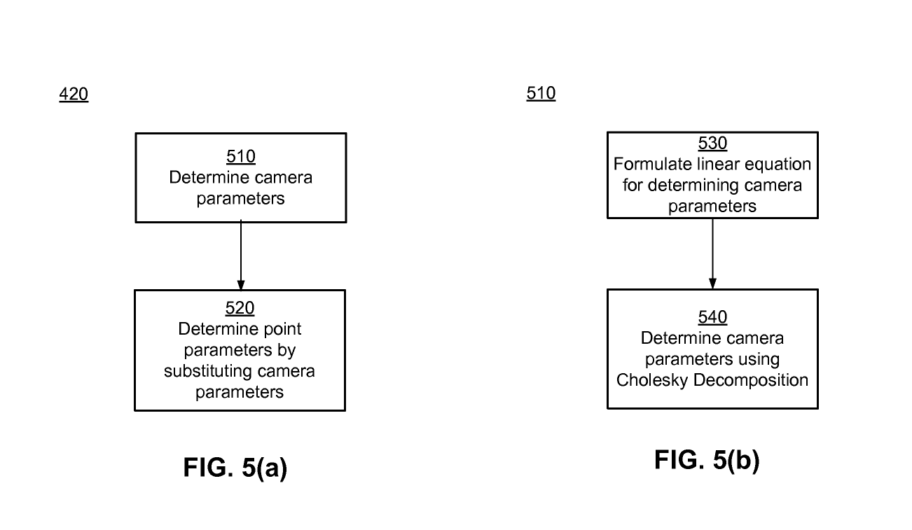

FIG. 5(a) is a flow diagram illustrating the details of the process for determining 420 the correction to the three-dimensional model, according to one embodiment of the present invention. The model correction module 340 invokes the camera parameter solver 360 for determining 510 the elements Δx_{c} representing corrections to the camera parameters. The camera parameter solver 360 determines 510 corrections to the camera parameters by solving equation (16). The model correction module 340 invokes the point parameter solver 350 for determining 520 the elements Δxₚ that represent the corrections to the point parameters. The point parameter solver 350 determines 520 the corrections to the point parameters by solving equation (26).

FIG. 5(b) is a flow diagram illustrating the details of the process for determining 510 the camera parameters by solving equation (16), according to one embodiment of the present invention. The left hand side of equation (16) is a product of the Schur complement matrix S with the corrections to the camera parameters represented by Δx_{c}. The camera parameter solver 360 formulates 530 linear equation (16) for determining the camera parameters. The left hand side of equation (16) comprises the Schur complement matrix S using equation (27) and the vector R as shown in equation (17). The camera parameter solver 360 solves the equation (16) to determine 540 the corrections to the camera parameters Δx_{c}. Equation (16) can be solved using linear equation solution techniques, for example, Cholesky Decomposition or the conjugate gradient method.

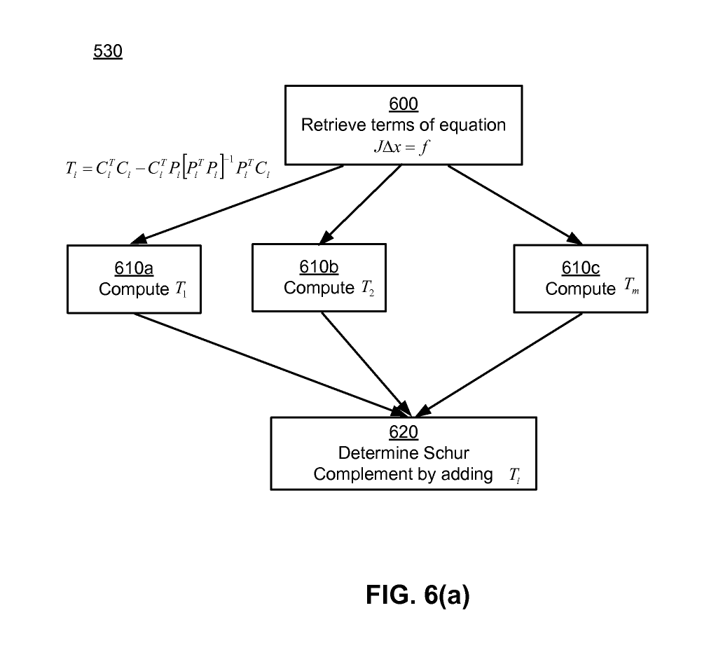

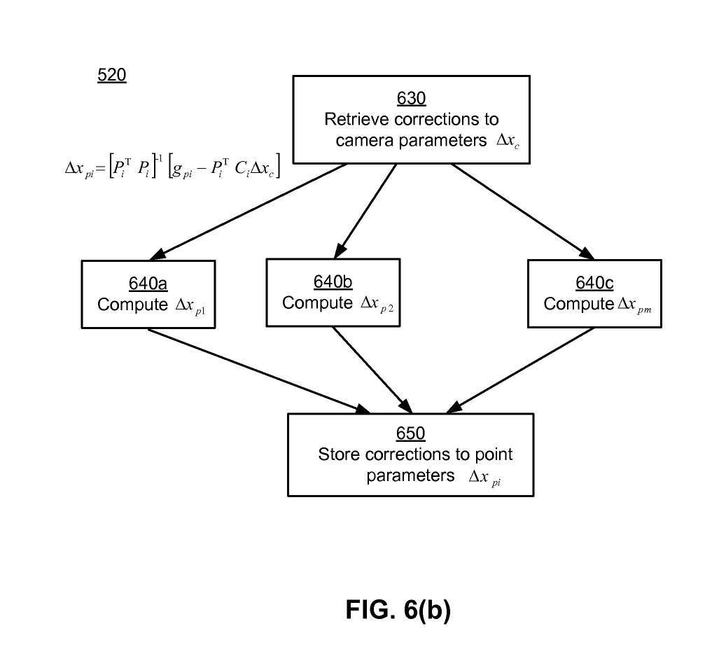

The sparsity structure of the J matrix as illustrated by equation (9) can be exploited to efficiently obtain the corrections to the camera parameters Δx_{c} and corrections to the point parameters Δxₚ. The sparsity structure of matrix J allows the Schur complement matrix S to be determined 530 independently for each point without considering Jacobian blocks for other points. FIG. 6(a) is a flow diagram illustrating the concurrency inherent in the process for determining 530 the Schur complement matrix for determining 510 the corrections to the camera parameters, according to one embodiment of the present invention. As shown in FIG. 6(a), the Schur complement matrix S can be computed as the sum of various terms represented by equation (30).

Tᵢ=Cᵢ^{T}Cᵢ−Cᵢ^{T}Pᵢ[Pᵢ^{T}Pᵢ]⁻¹Pᵢ^{T}Cᵢ (30)

The camera parameter solver 360 retrieves 600 the terms of equation (10) including terms Cᵢ and Pᵢ for various points i. As illustrated by equation (30) each term Tᵢ can be computed 610 independent of the other terms tⱼ where j is different from i. Accordingly, the camera parameter solver 360 can retrieve only the terms relevant to the point i at a time while ignoring the remaining points. This allows the camera parameter solver 360 to determine the term Tᵢ with minimal memory resources since the camera parameter solver 360 does not have to load terms for points other than point i. Furthermore, the computation of term Tᵢ is efficient since the camera parameter solver 360 does not have to load or process the terms related to other points. If the camera parameter solver 360 has access to multiple processors it can compute the different terms Tᵢ in parallel. The camera parameter solver 360 determines 620 the Schur complement matrix S by adding the terms T. The camera parameter solver 360 can maintain a partial sum of the terms Tᵢ as they are computed or compute 610 all the terms T ᵢ and then add them. The camera parameter solver 360 can also utilize any parallelism inherent in addition of the various terms Tᵢ, for example, the camera parameter solver 360 can add sets of terms Tᵢ in parallel and then add their partial sums.

The camera parameter solver 360 may use a sparse or dense implementation of Cholesky Factorization or the conjugate gradient method to solve equation (16) to determine the camera parameters Δx_{c}. FIG. 6(b) is a flow diagram illustrating the concurrency inherent in the process for determining 520 the corrections to the point parameters, according to one embodiment of the present invention. The point parameter solver 350 retrieves 630 the camera parameters Δx_{c} to solve the equation (29).

As shown in equation (29), the point parameter solver 350 can determine 640 each term Δxₚᵢ corresponding to point i independent of the other points given the value of Δx_{c}. This allows the point parameter solver 350 to determine the term Δxₚᵢ with minimal memory resources since during processing of terms for point i, the point parameter solver 350 does not have to load terms for points other than i except for value of Δx_{c}. Furthermore, the computation of term Δxₚᵢ is efficient since the point parameter solver 350 loads fewer terms at a time. The point parameter solver 350 stores the terms Δxₚᵢ in the 3-D model store 330.

### Jacobian Free 3-D Reconstruction Process

The Jacobian matrix J represented by equation (9) can be significantly large for typical problems. Therefore, methods that require the entire Jacobian matrix to be present in memory for executing the processes shown in FIG. 4 and FIG. 5 require use of expensive computers with large memory. Embodiments perform the computation illustrated in the flowcharts of FIGS. 4 and 5 without storing the entire Jacobian matrix J in memory at the same time. Only a small portion of the Jacobian matrix J is computed and stored in memory. New portions of Jacobian matrix reuse the storage used by previously computed portions of the Jacobian matrix. As a result, the size of memory used for performing the processes illustrated in the flowcharts of FIGS. 4 and 5 is significantly smaller than the size of memory required for storing the entire Jacobian matrix J. This allows the processes shown in FIG. 4 and FIG. 5 to be performed using less expensive hardware.

The computations of the equations (38), (39), and (43) can be performed using particular row blocks of the matrix J, without requiring simultaneous access to other parts of the matrix J. A row block Jᵢ=[A_{i,j}, B_{i,1}, . . . , B_{i,k}] can be computed by differentiating the i^{th} residual fᵢ. For example, the computation of the equations (38), (39), and (43) for a given point i, say i=i1, can be performed by determining the values Jᵢ₁ on demand. After the computations associated with point i=i1 are completed for an equation, the values Jᵢ₁ can be discarded. This process is repeated for another value of i, say i=i2 by determining Jᵢ₂. The storage previously used for storing Jᵢ₁ can be used for storing Jᵢ₂. As a result, the computations of equations (38), (39), and (43) can be performed by storing only one or a few row blocks of the matrix J in memory at a time. This provides for a Jacobian-free computation for solving the non-linear least squares problem, resulting in substantial memory savings for large scale problems.

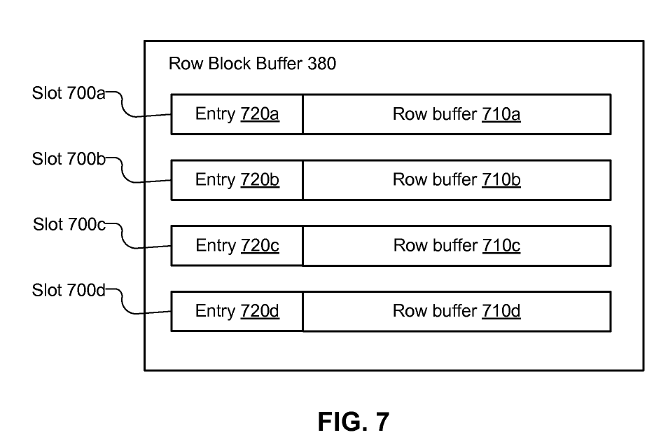

FIG. 7 shows the row block buffer 380 for storing row blocks of the Jacobian matrix, in accordance with an embodiment of the invention. Each row block typically comprises a small number of rows, for example, 2-3 rows. As shown in FIG. 7, the row block buffer 380 stores a fixed number m of row blocks 710, for example, m=4 in FIG. 7. The structure illustrated in FIG. 7 can be used to implement a circular buffer for storing row blocks of Jacobian J. The information corresponding to each row block is stored in a slot 700. Each slot 700 comprises an entry 720 and the row block buffer 710 for storing the values of a row block. In an embodiment, the slot 700 stores a pointer to a memory location that stores the row block buffer 710. Initially all entries 720 store a special value, for example, −1 indicating that the slot is not in use. The row block j is assigned to the slot k=(j mod m). In response to a request for the jth row block, the Jacobian interface 390 checks if the entry 720 of slot k stores the value j. If the value of the entry 720 in the slot k stores value of j, the row block buffer 710 of slot k stores the row block j. Accordingly, the Jacobian interface 390 returns the row block 710 stored in the slot k. If the value of the entry 720 in the slot k does not store the value of j, the Jacobian interface 390 computes the value of Jᵢ and stores the value in the row buffer 710 of the slot k. The Jacobian interface 390 updates the value of the entry field of slot k to store the value of j. As a result, the value of the row block j is available for any subsequent computation until the value is overwritten by another row block.

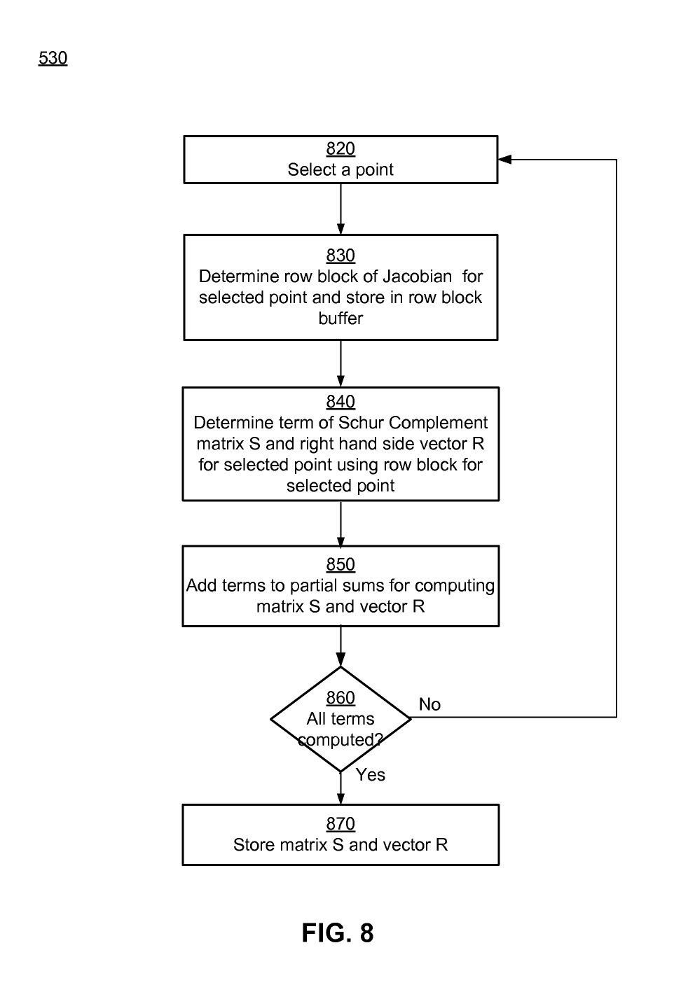

FIG. 8 is a flow diagram illustrating a process for formulating 530 the linear equation (27) for determining the corrections to camera parameters, without storing the entire Jacobian matrix in memory at the same time, according to one embodiment of the present invention. The camera parameters solver 360 selects 820 a point for processing. The camera invokes the Jacobian interface 390 to obtain the row block for the selected point. The Jacobian interface 390 determines 830 the row blocks for the selected point and stores the value in the row block buffer 710. If the corresponding row block buffer stores the value of another row block that was previously computed, the new row block value replaces the previous row block value. If the row block for the selected point is already available in the row buffer 710, the Jacobian interface 390 returns the available row block.

The camera parameters solver 360 determines 840 the term Tᵢ shown in equation (3) for determining the Schur complement matrix S and the term Uᵢ shown in equation (29) for determining the right hand side vector R. The camera parameters solver 360 adds 850 the term Tᵢ to a partial sum of terms for computing the Schur complement matrix S and the terms Uᵢ to a partial sum for computing the right hand side vector R. The camera parameters solver 360 repeats the above steps 820, 830, 840, and 850 until all terms Tᵢ are determined 860 to be computed. The camera parameters solver 360 stores 870 the Schur complement matrix and the vector R.

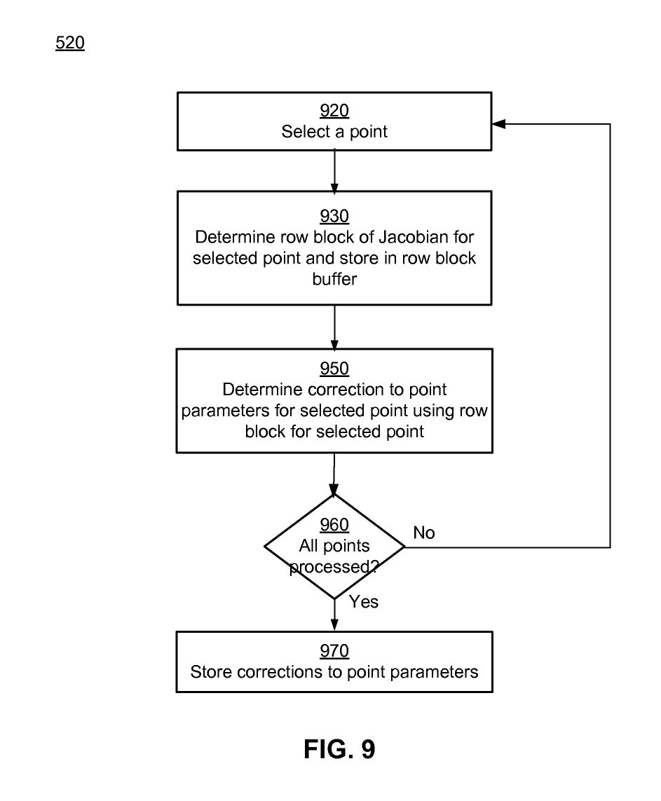

FIG. 9 is a flow diagram illustrating a process for determining a correction to the point parameters given the camera parameters, without storing the entire Jacobian matrix in memory at the same time, according to one embodiment of the present invention. The point parameter solver 350 selects 920 a point for determining the corrections to the corresponding point parameters. The point parameter solver 350 invokes the Jacobian interface 390 to obtain the row block for the selected point. As described for the process in FIG. 8, the Jacobian interface 390 determines 930 the row blocks for the selected point and stores the value in the row block buffer 710, thereby replacing any previously stored row block in the row block buffer 710. If the row block for the selected point is already available in the row buffer 710, the Jacobian interface 390 returns the available row block. The point parameter solver 350 determines 950 the correction to the point parameter Δxₚᵢ corresponding to the selected point using the equation (29). The point parameter solver 350 repeats the steps 920, 930, and 950 until the corrections to the point parameters for all points are determined 960. The point parameter solver 350 stores 970 the corrections to the point parameters.

### Prefetching Row Blocks

Since the processing illustrated in FIG. 8 and FIG. 9 can performed for each point independent of other points, the points can be selected 820, 920 in any arbitrary order. For example, an embodiment can select 820, 920 the points in a sequence incrementing the index i of the point by one each time. Other embodiments can process the points in any predetermined order, for example, as a decreasing sequence of indices i. If multiple processors are available, the processing of multiple points can be performed in parallel. In a system that allows multiple threads to execute concurrently, the processing for each point can be performed concurrently by different threads.

The Jacobian interface 390 can initiate the computation of the row blocks even before it receives the request for the row block. For example, if the points are processed as a sequence incrementing the index i of the point by one each time, the Jacobian interface 390 can estimate the row block that it needs to compute next. For example, if the current request to the Jacobian interface 390 is for row block for point j, the next request will be for row block j+1, followed by j+2, j+3, and so on. In an embodiment, the Jacobian interface 390 maintains a queue of tasks or threads. When the Jacobian interface 390 receives the request for row block j, the Jacobian interface 390 creates requests for prefetching the row blocks j+1, j+2, . . . , j+c, where c is a predetermined constant. When the request for the row block j+1 is received, the Jacobian interface 390 checks if the row block j+1 has already been computed. If the row block j+1 has already been computed when the request is received, the row block j+1 is returned. If a thread is busy computing the row block j+1, the Jacobian interface 390 waits for the thread to complete and returns the row block when the computation is finished. If the row block j+1 has not been computed and there is no thread that is currently computing the row block j+1, the Jacobian interface 390 computes the value of the row block and returns it. Prefetching of row blocks ensures that when the Jacobian interface 390 receives a request for a particular row block, there is high likelihood that the row block has been prefetched and is available in row block buffer. As a result, the module requesting the row block does not have to wait for the result.

### Solving Other Optimization Problems

The techniques described herein can be used for other applications that are formulated as optimization problems, for example, other image processing applications. An example application of these techniques performs color blending in an image. A large image may comprise multiple photos captured separately that are juxtaposed adjacent to each other. For example, a satellite image of a large geographical region may be formed by taking multiple satellite images of smaller portions of the geographical regions and placing them adjacent to each other. Since the different satellite images may be captured at different times of the day or even different days of the year, these images may have very different color distributions. Such images may not be visually appealing since a viewer can distinguish between the different portions of the images captured independently. The process of color blending adjusts the color distribution of these independent images so as to present an overall image with a relatively uniform color distribution. The process of color blending can be formulated as a process that minimizes the color disparity between adjacent images while keeping their color as close as possible to their original color. This minimization problem can be solved using the optimization techniques described herein.

The color blending problem (or other non-linear least squares optimization problems) may be formulated as a Jacobian matrix with a structure that may be different from that shown in equation (10). However, heuristics can be used to formulate a general sparse non-linear least squares problem as a Jacobian matrix with structure shown in equation (10), i.e., a Jacobian matrix comprising Jacobian blocks corresponding to point parameter blocks and camera parameter blocks. The sparse Jacobian matrix obtained from any given problem can be represented as a graph. Each vertex of the graph represents a Jacobian block corresponding to a parameter block and an edge connects two vertices if the two Jacobian blocks corresponding to the two vertices co-occur in any residual block, i.e. the corresponding entries in any row block of the Jacobian is non-zero. An independent set of vertices of the graph is determined. An independent set of vertices is a set of vertices such that no two vertices of the independent set are connected by an edge. The Jacobian blocks corresponding to the independent set of vertices are treated as Jacobian blocks Pᵢ corresponding to point parameters and the remaining vertices are treated as Jacobian blocks Cⱼ corresponding to camera parameters. Accordingly, the problem is formulated as a Jacobian matrix with the structure shown in equation (10). The resulting efficiency of the process shown in FIG. 4 for solving the formulated non-linear least squares optimization problem depends on the size of the independent set. Larger independent sets obtained from the graph representation result in better efficiency of the process. The determination of an independent set of a graph in general is an NP-complete problem that is not expected to have a polynomial time solution. In an embodiment, a greedy strategy is used to determine the independent set of the vertices.

### Computer Architecture

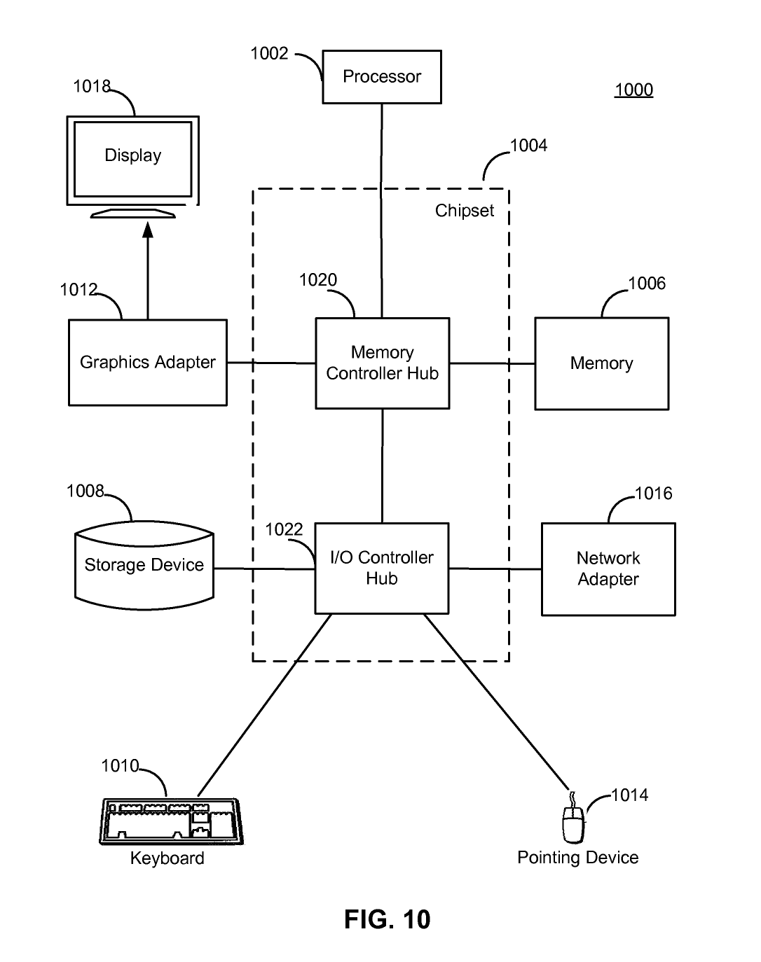

FIG. 10 is a high-level block diagram illustrating an example computer 1000, such as the computer system 300 shown in FIG. 3. The computer 1000 includes at least one processor 1002 coupled to a chipset 1004. The chipset 1004 includes a memory controller hub 1020 and an input/output (I/O) controller hub 1022. A memory 1006 and a graphics adapter 1012 are coupled to the memory controller hub 1020, and a display 1018 is coupled to the graphics adapter 1012. A storage device 1008, keyboard 1010, pointing device 1014, and network adapter 1016 are coupled to the I/O controller hub 1022. Other embodiments of the computer 1000 have different architectures.

The storage device 1008 is a non-transitory computer-readable storage medium such as a hard drive, compact disk read-only memory (CD-ROM), DVD, or a solid-state memory device. The memory 1006 holds instructions and data used by the processor 1002. In an embodiment, the memory 1006 is a random access memory (RAM) that has faster access time compared to a storage device 1008, for example, hard drive, CD-ROM or DVD. Typically, the total storage capacity of storage device 1008 is much larger than the total storage capacity of memory 1006. If a process uses a large amount of data, the memory 1006 may not be large enough to accommodate all the data used by the process. Frequently used data may be stored in memory 1006 for fast access in order to improve overall performance. The pointing device 1014 is a mouse, track ball, or other type of pointing device, and is used in combination with the keyboard 1010 to input data into the computer system 1000. The graphics adapter 1012 displays images and other information on the display 1018. The network adapter 1016 couples the computer system 1000 to one or more computer networks.

The computer 1000 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 1008, loaded into the memory 1006, and executed by the processor 1002.

The types of computers 1000 used as the computer systems of FIG. 3 can vary depending upon the embodiment and requirements. In some embodiments, the computer system 300 might include one or more blade computers lacking displays, keyboards, and/or other devices shown in FIG. 10. In other embodiments, the computer system 300 might comprise a mobile phone or other such device with a touch-sensitive display and limited processing power.

### Alternative Embodiments

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconstructing a 3-D model from a given set of images of a scene. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for refining a three-dimensional model of a scene from a set of images of the scene captured using one or more cameras, the method comprising:
iteratively modifying a set of parameters representing a three-dimensional model of a scene, the modifying comprising:
determining corrections to the set of parameters by solving a sparse linear system of equations comprising a Jacobian matrix obtained from residuals representing an error in the three dimensional model, comprising, for an iteration:
for each point in the scene,
determining a row block of the Jacobian matrix for the point;
storing the row block in memory, the storing comprising replacing a stored row block for another point determined during the current iteration;
determining a matrix term and a vector term using the stored row block of the Jacobian matrix;
formulating a linear equation comprising a sum of the matrix terms and a vector obtained by combining the vector terms;
solving the linear equation to determine corrections to the set of parameters; and
refining the set of parameters based on the corrections to produce a refined three-dimensional model of the scene.

2. The method of claim 1, wherein the residuals representing the error in the three dimensional model comprises a difference between a position of a point in an image of the scene captured by a camera and a projection of the point represented by the three dimensional model onto an image plane of the camera.

3. The method of claim 1, further comprising:
allocating storage for storing a fixed number of row blocks, the fixed number being less than the total number of row blocks of the Jacobian matrix, wherein the allocated storage is used for storing the row blocks for all of the points of the scene.

4. The method of claim 1, wherein the set of parameters comprises point parameters describing points of the scene and camera parameters describing the cameras.

5. The method of claim 1, wherein the refining of the three-dimensional model performed by a computer without storing the Jacobian matrix entirely in memory of the computer at the same time.

6. The method of claim 1, wherein determining a row block of the Jacobian matrix for a point comprises differentiating a residual corresponding to the point.

7. The method of claim 1, wherein determining the set of parameters comprises:
determining camera parameters by solving the linear equation;
determining point parameters using back substitution, comprising:
for each point of the scene:
determining a row block of the Jacobian matrix for the point;
storing the row block in memory, the storing comprising replacing a stored row block for another point determined during the back substitution; and
determining a value of the point parameter for the point using the stored row block.

8. The method of claim 1, wherein determining corrections to the set of parameters further comprises prefetching row blocks for one or more points, comprising:
for each point in the scene,
initiating tasks for determining row blocks of the Jacobian matrix for one or more points for which the matrix term and the vector term has not been determined for the current iteration.

9. The method of claim 8, wherein determining a row block of the Jacobian matrix for the point comprises checking whether the row block for the point has been prefetched.

10. A computer-implemented system for refining a three-dimensional model of a scene from a set of images of the scene captured using one or more cameras, the system comprising:
a computer processor; and
a computer-readable storage medium storing computer program modules configured to execute on the computer processor, the computer program modules comprising:
a 3-D model construction module configured to:
iteratively modify a set of parameters representing a three-dimensional model of a scene, the modifying comprising:
determining corrections to the set of parameters by solving a sparse linear system of equations comprising a Jacobian matrix obtained from residuals representing an error in the three dimensional model, comprising, for an iteration:
for each point in the scene,
determining a row block of the Jacobian matrix for the point;
storing the row block in memory, the storing comprising replacing a stored row block for another point determined during the current iteration;
determining a matrix term and a vector term using the stored row block of the Jacobian matrix;
formulating a linear equation comprising a sum of the matrix terms and a vector obtained by combining the vector terms;
solving the linear equation to determine corrections to the set of parameters; and
refining the set of parameters based on the corrections to produce a refined three-dimensional model of the scene.

11. The system of claim 10, wherein the residuals representing the error in the three dimensional model comprises a difference between a position of a point in an image of the scene captured by a camera and a projection of the point represented by the three dimensional model onto an image plane of the camera.

12. The system of claim 10, further comprising:
allocating storage for storing a fixed number of row blocks, the fixed number being less than the total number of row blocks of the Jacobian matrix, wherein the allocated storage is used for storing the row blocks for all of the points of the scene.

13. The system of claim 10, wherein the refining of the three-dimensional model performed by a computer without storing the Jacobian matrix entirely in memory of the computer at the same time.

14. The system of claim 10, wherein determining the set of parameters comprises:
determining camera parameters by solving the linear equation;
determining point parameters using back substitution, comprising:
for each point of the scene:
determining a row block of the Jacobian matrix for the point;
storing the row block in memory, the storing comprising replacing a stored row block for another point determined during the back substitution; and
determining a value of the point parameter for the point using the stored row block.

15. The system of claim 10, wherein determining corrections to the set of parameters further comprises prefetching row blocks for one or more points, comprising:
for each point in the scene,
initiating tasks for determining row blocks of the Jacobian matrix for one or more points for which the matrix term and the vector term has not been determined for the current iteration.

16. A computer program product having a non-transitory computer-readable storage medium storing computer-executable code for refining a three-dimensional model of a scene from a set of images of the scene captured using one or more cameras, the code comprising:
a 3-D model construction module configured to:
iteratively modify a set of parameters representing a three-dimensional model of a scene, the modifying comprising:
determining corrections to the set of parameters by solving a sparse linear system of equations comprising a Jacobian matrix obtained from residuals representing an error in the three dimensional model, comprising, for an iteration:
for each point in the scene,
determining a row block of the Jacobian matrix for the point;
storing the row block in memory, the storing comprising replacing a stored row block for another point determined during the current iteration;
determining a matrix term and a vector term using the stored row block of the Jacobian matrix;
formulating a linear equation comprising a sum of the matrix terms and a vector obtained by combining the vector terms;
solving the linear equation to determine corrections to the set of parameters; and
refining the set of parameters based on the corrections to produce a refined three-dimensional model of the scene.

17. The computer program product of claim 16, wherein the residuals representing the error in the three dimensional model comprises a difference between a position of a point in an image of the scene captured by a camera and a projection of the point represented by the three dimensional model onto an image plane of the camera.

18. The computer program product of claim 16, further comprising:
allocating storage for storing a fixed number of row blocks, the fixed number being less than the total number of row blocks of the Jacobian matrix, wherein the allocated storage is used for storing the row blocks for all of the points of the scene.

19. The computer program product of claim 16, wherein the refining of the three-dimensional model performed by a computer without storing the Jacobian matrix entirely in memory of the computer at the same time.

20. The computer program product of claim 16, wherein determining the set of parameters comprises:
determining camera parameters by solving the linear equation;
determining point parameters using back substitution, comprising:
for each point of the scene:
determining a row block of the Jacobian matrix for the point;
storing the row block in memory, the storing comprising replacing a stored row block for another point determined during the back substitution; and
determining a value of the point parameter for the point using the stored row block.

21. The computer program product of claim 16, wherein determining corrections to the set of parameters further comprises prefetching row blocks for one or more points, comprising:
for each point in the scene,
initiating tasks for determining row blocks of the Jacobian matrix for one or more points for which the matrix term and the vector term has not been determined for the current iteration.
